(19) United States
(12) Patent Application Publication
(10) Pub. No.: US 2025/0293759 A1
(43) Pub. Date: Sep. 18, 2025

(54) SUB-BAND FULL-DUPLEX AWARENESS FOR A NETWORK-CONTROLLED REPEATER

(71) Applicant: QUALCOMM Incorporated, San Diego, CA (US)

(72) Inventors: Navid ABEDINI, Basking Ridge, NJ (US); Qian ZHANG, Basking Ridge, NJ (US); Junyi LI, Greentown, PA (US); Tao LUO, San Diego, CA (US)

(21) Appl. No.: 18/608,655

(22) Filed: Mar. 18, 2024

(51) Int. Cl. H04B 7/155; H04L 5/14

(52) U.S. Cl. CPC H04B 7/155; H04L 5/14

(57) ABSTRACT

Various aspects of the present disclosure generally relate to wireless communication. In some aspects, a repeater node may receive, from a network node, sub-band full-duplex (SBFD) configuration information associated with the network node, wherein the SBFD configuration information indicates one or more SBFD symbols and indicates a forwarding direction for the repeater node in the one or more SBFD symbols. The repeater node may forward communications that are received in the one or more SBFD symbols in the forwarding direction indicated in the SBFD configuration information. Numerous other aspects are described.

### FIELD OF THE DISCLOSURE

Aspects of the present disclosure generally relate to wireless communication and specifically relate to techniques, apparatuses, and methods associated with sub-band full-duplex (SBFD) awareness for a network-controlled repeater (NCR).

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a repeater node for wireless communication. The repeater node may include one or more memories and one or more processors coupled to the one or more memories. The one or more processors may be configured to receive, from a network node, sub-band full-duplex (SBFD) configuration information associated with the network node, wherein the SBFD configuration information indicates one or more SBFD symbols and indicates a forwarding direction for the repeater node in the one or more SBFD symbols. The one or more processors may be configured to forward communications that are received in the one or more SBFD symbols in the forwarding direction indicated in the SBFD configuration information.

Some aspects described herein relate to a method of wireless communication performed by a repeater node. The method may include receiving, from a network node, SBFD configuration information associated with the network node, wherein the SBFD configuration information indicates one or more SBFD symbols and indicates a forwarding direction for the repeater node in the one or more SBFD symbols. The method may include forwarding communications that are received in the one or more SBFD symbols in the forwarding direction indicated in the SBFD configuration information.

Some aspects described herein relate to an apparatus for wireless communication. The apparatus may include means for receiving, from a network node, SBFD configuration information associated with the network node, wherein the SBFD configuration information indicates one or more SBFD symbols and indicates a forwarding direction for the apparatus in the one or more SBFD symbols. The apparatus may include means for forwarding communications that are received in the one or more SBFD symbols in the forwarding direction indicated in the SBFD configuration information.

Some aspects described herein relate to a non-transitory computer-readable medium that stores a set of instructions for wireless communication by a repeater node. The set of instructions, when executed by one or more processors of the repeater node, may cause the repeater node to receive, from a network node, SBFD configuration information associated with the network node, wherein the SBFD configuration information indicates one or more SBFD symbols and indicates a forwarding direction for the repeater node in the one or more SBFD symbols. The set of instructions, when executed by one or more processors of the repeater node, may cause the repeater node to forward communications that are received in the one or more SBFD symbols in the forwarding direction indicated in the SBFD configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex communication in a wireless network, in accordance with the present disclosure.

FIG. 5 is a diagram illustrating examples of full-duplex deployment scenarios, in accordance with the present disclosure.

FIG. 6A is a diagram illustrating examples of different duplexing modes, in accordance with the present disclosure.

FIG. 6B is a diagram illustrating an example of sub-band full-duplex (SBFD) activation, in accordance with the present disclosure.

FIG. 7 is a diagram illustrating an example of a network-controlled repeater (NCR), in accordance with the present disclosure.

FIGS. 8A-8C are diagrams illustrating examples associated with SBFD awareness for an NCR, in accordance with the present disclosure.

FIG. 9 is a flowchart illustrating an example process performed, for example, by an NCR, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some cases, a wireless network may include one or more repeaters (e.g., one or more network-controlled repeater (NCR) nodes) that may receive a radio frequency (RF) signal (for example, an analog RF signal) from a network node, amplify the RF signal, and transmit or forward the amplified RF signal to a user equipment (UE). For example, the one or more repeaters may include one or more analog repeaters, sometimes referred to as Layer 1 (L1) repeaters. Additionally or alternatively, the one or more repeaters may include one or more wireless transmission reception points (TRPs) acting as a distributed unit (DU) or a radio unit (RU) that communicates wirelessly with a network node acting as a central unit (CU) or an access node controller. The one or more repeaters may receive, amplify, and transmit the analog RF signals without performing analog-to-digital conversion of the analog RF signals and/or without performing any digital signal processing on the RF signals. Alternatively, the one or more repeaters may transmit the received RF signals after decoding the received RF signals and/or modifying information carried in the received RF signals. In this way, the one or more repeaters may improve network performance and/or may increase reliability by providing link diversity and/or extending a communication coverage area of the network node.

Furthermore, another technique that may be used to improve performance in a wireless network is to enable full-duplex communication, which generally includes simultaneous bi-directional communication between devices in the wireless network. For example, a network node operating in a full-duplex mode may receive an uplink communication and transmit a downlink communication at the same time (e.g., in the same slot or the same symbol). For example, a network node may support a sub-band full-duplex (SBFD) communication mode, which may also be referred to as a “sub-band frequency division duplex (SBFDD)” mode, a “flexible duplex” mode, or the like. In the SBFD mode, a network node may receive an uplink communication from a first UE and transmit a downlink communication to a second UE at the same time, but on different frequency resources. For example, the different frequency resources may be sub-bands of a frequency band, such as a time division duplexing (TDD) band. In this case, frequency resources used for downlink communication may be separated from frequency resources used for uplink communication, in the frequency domain, by one or more guard bands. In this way, the SBFD mode may result in increased throughput by allowing simultaneous uplink and downlink communication, reduced latency by allowing uplink and/or downlink communication to occur earlier in time, and/or increased spectral efficiency by simultaneously utilizing downlink and uplink resources.

However, in some network deployments, the SBFD communication mode may be supported only by network nodes, with other nodes such as UEs and NCRs limited to TDD or half-duplex operation (e.g., only transmitting or only receiving in any particular transmission time interval). For example, an NCR typically uses semi-static TDD information that a (controlling) network node provides to a mobile termination (MT) component of the NCR to determine a forwarding direction (downlink or uplink) to be used by a forwarding (FWD) component of the NCR in each symbol or slot. As described herein, the FWD component of an NCR typically forwards a wideband analog signal over an operating bandwidth that encompasses one or more component carriers that the MT component uses to communicate with the network node, and the FWD component is disabled or turned off within semi-static flexible resources (e.g., that can be used as uplink or downlink resources). Although UEs are often limited to half-duplex operation, a UE limited to half-duplex operation may be SBFD-aware (e.g., may receive information indicating an SBFD configuration of a network node) such that the SBFD-aware UE can adjust scheduling, measurement, and/or other operations within SBFD symbols.

Various aspects relate generally to providing a repeater node with information related to an SBFD configuration associated with a network node such that the repeater node may adjust operations within one or more SBFD symbols and/or non-SBFD symbols to improve forwarding services used to extend the coverage of the network node. For example, in some aspects, the repeater node may be provided with information that indicates the SBFD configuration associated with a network node and indicates whether the repeater node is to forward communications in an uplink direction or a downlink direction within one or more SBFD symbols. For example, in some aspects, the network node may provide the repeater node with a semi-static indication of the SBFD configuration used by the network node, which may indicate SBFD time resources (e.g., SBFD symbols or SBFD slots) and/or SBFD sub-band configurations. Furthermore, the forwarding direction to be used in the SBFD symbols may be indicated dynamically or semi-statically, and the forwarding direction may be common to all SBFD symbols or may be indicated granularly (e.g., with different forwarding directions to be used in different sets or subsets of SBFD symbols). Additionally, or alternatively, the forwarding direction may be implicitly indicated according to one or more configurations or rules, or based on an implementation of the repeater node. Furthermore, some aspects described herein relate to forwarding operations that may be used by the repeater node based on a sub-band filtering capability of the repeater node, SBFD configuration indications that may be based on an SBFD configuration provided for an SBFD-capable MT component of the repeater node, different communication configurations to be used in SBFD and/or non-SBFD symbols, and/or techniques to apply the SBFD configuration associated with a network node for a repeater node having bi-directional forwarding capabilities.

Particular aspects of the subject matter described in this disclosure can be implemented to realize one or more of the following potential advantages. In some examples, by providing a repeater node with information related to an SBFD configuration used by a network node that controls the repeater node, the described techniques can be used to configure operations to improve forwarding operations and/or forwarding service that the repeater node provides for the repeater node that operates in accordance with the SBFD configuration. For example, the repeater node may be configured to forward communications in an uplink direction in one or more SBFD symbols to improve uplink performance and/or to forward communications in a downlink direction in one or more SBFD symbols to improve downlink performance. Furthermore, some aspects described herein can be used to dynamically or semi-statically indicate the forwarding direction to be used by the repeater node to improve performance during time periods associated with uplink-heavy or downlink-heavy traffic.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, RF sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

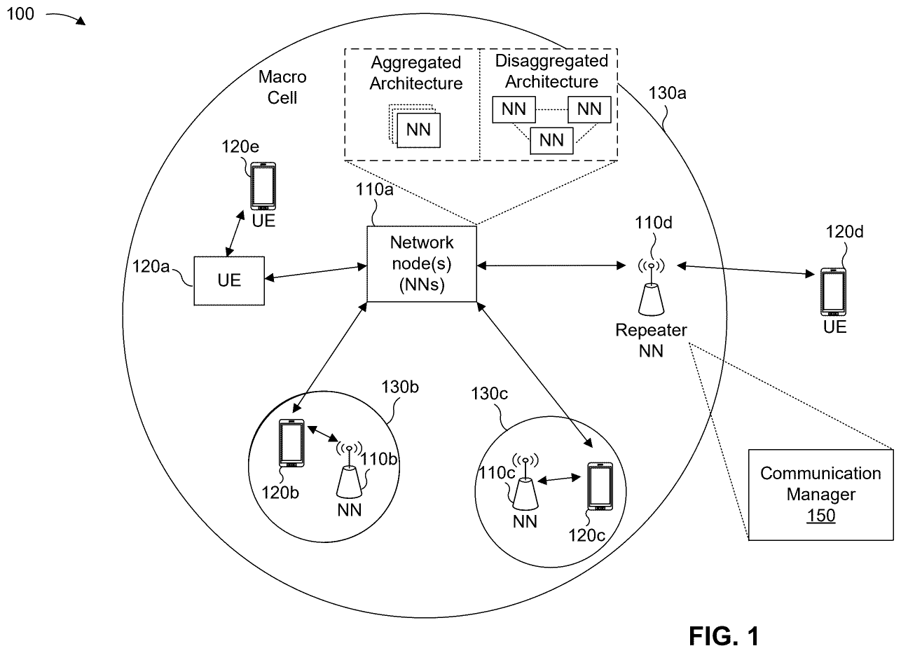

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a TRP, a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more CUs, one or more DUs, and/or one or more RUs. A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, repeater network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, relay network nodes, and repeater network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes, repeater network nodes, or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that forwards communications may be referred to as a repeater network node, a repeater station, a repeater, a relay network node, a relay station, or a relay. A repeater or relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a repeater network node) may communicate with the network node 110a (for example, a macro network node) and the UE 120d in order to facilitate communication between the network node 110a and the UE 120d. Additionally or alternatively, a UE 120 may be or may operate as a repeater or relay station that can forward transmissions to or from other UEs 120. A UE 120 that forwards communications may be referred to as a UE repeater, a repeater UE, a UE relay, or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve TDD, in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a repeater node (e.g., repeater network node 110d) may include a communication manager 150. As described in more detail elsewhere herein, the communication manager 150 may receive, from a network node (e.g., network node 110a), SBFD configuration information associated with the network node, wherein the SBFD configuration information indicates one or more SBFD symbols and indicates a forwarding direction for the repeater node in the one or more SBFD symbols; and forward communications that are received in the one or more SBFD symbols in the forwarding direction indicated in the SBFD configuration information. Additionally, or alternatively, the communication manager 150 may perform one or more other operations described herein.

As indicated above, FIG. 1 is provided as an example. Other examples may differ from what is described with regard to FIG. 1.

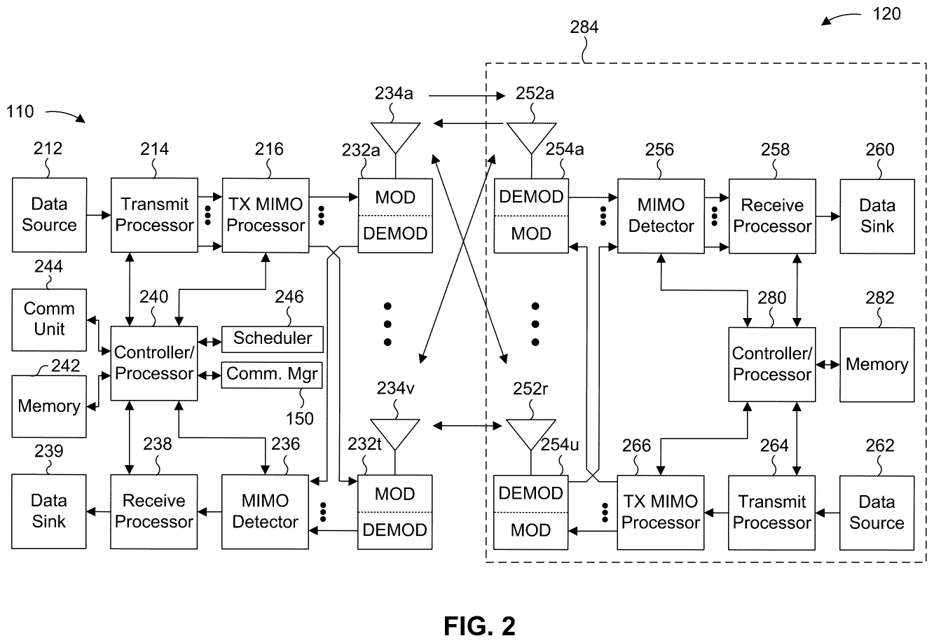

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, and/or a memory 282, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254.

Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

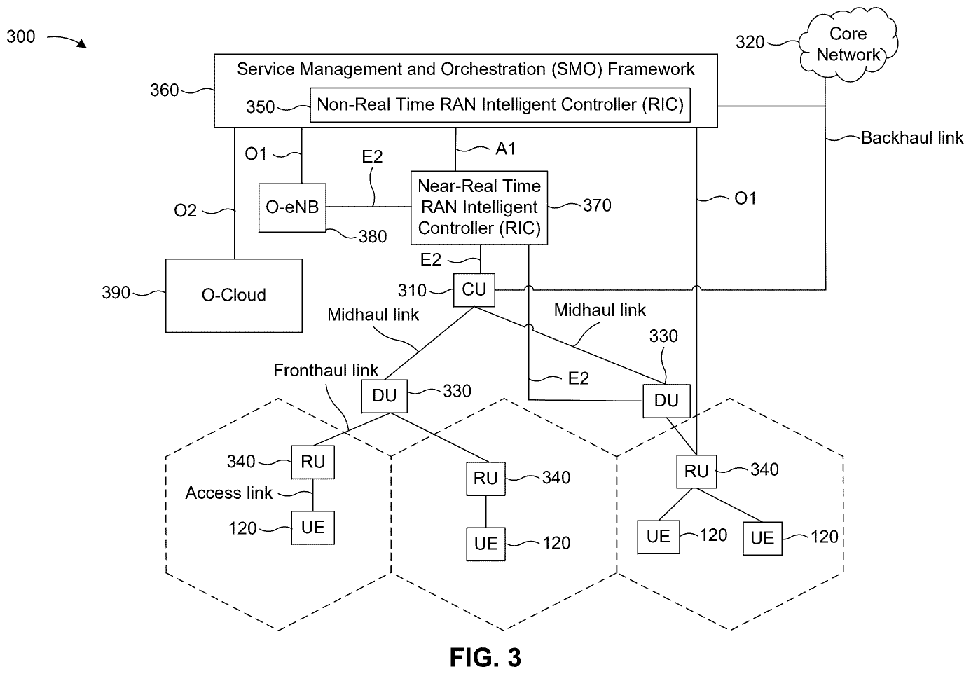

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

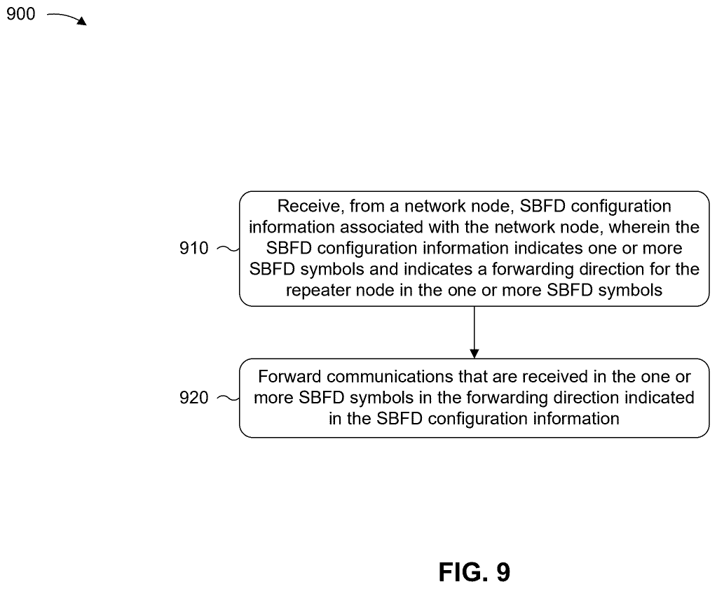

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with SBFD awareness for an NCR, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9 or other processes as described herein (alone or in conjunction with one or more other processors). In some aspects, a repeater node, an NCR, or an NCR node described herein is the network node 110 shown in FIG. 2, is included in the network node 110 shown in FIG. 2, includes one or more components of the network node 110 shown in FIG. 2, and/or includes one or more components of the UE 120 shown in FIG. 2. The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9 or other processes as described herein. In some examples, executing instructions may include running the instructions, converting the instructions, compiling the instructions, and/or interpreting the instructions, among other examples.

In some aspects, the repeater node includes means for receiving, from a network node 110, SBFD configuration information associated with the network node 110, wherein the SBFD configuration information indicates one or more SBFD symbols and indicates a forwarding direction for the repeater node in the one or more SBFD symbols; and/or means for forwarding communications that are received in the one or more SBFD symbols in the forwarding direction indicated in the SBFD configuration information. In some aspects, the means for the repeater node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. Additionally, or alternatively, the means for the repeater node to perform operations described herein may include, for example, one or more of antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

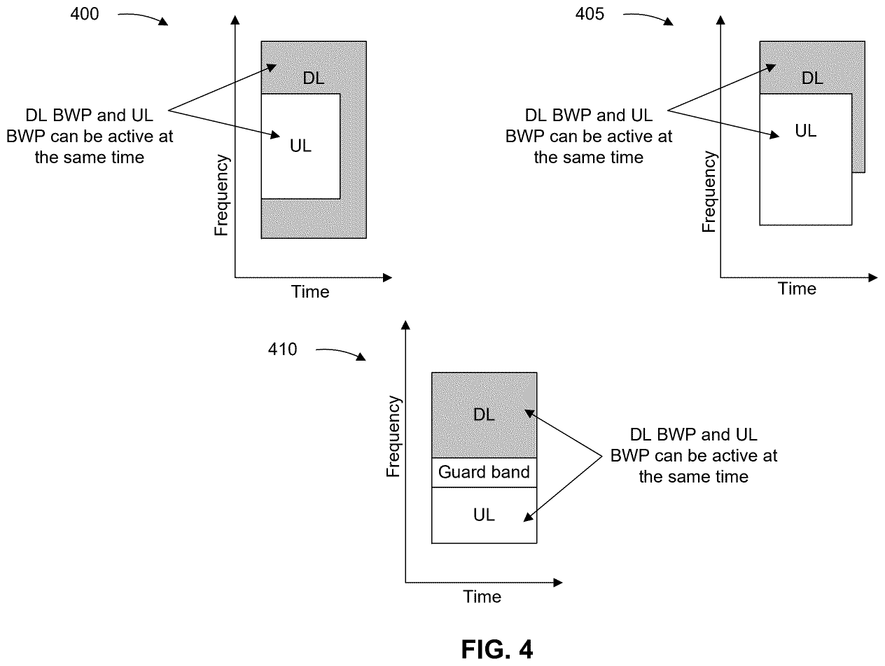

FIG. 4 is a diagram illustrating examples 400, 405, and 410 of full-duplex communication in a wireless network, in accordance with the present disclosure. As described herein, “full-duplex communication” refers to simultaneous uplink and downlink communication in a wireless network, which may be a capability of a UE, a network node, or another suitable device (e.g., an MT component and/or an FWD component of an NCR). For example, a UE operating in a full-duplex mode may transmit an uplink communication and receive a downlink communication at the same time (e.g., in the same slot or the same symbol), and a network node operating in a full-duplex mode may receive an uplink communication and transmit a downlink communication at the same time. “Half-duplex communication” in a wireless network refers to unidirectional communications (e.g., only downlink communication or only uplink communication) at a given time (e.g., a device only transmits or only receives in a given slot or a given symbol). In some cases, one or more nodes in a wireless network may support full-duplex communication and half-duplex communication, and other nodes may support half-duplex communication only. For example, in some aspects, a network node may support full-duplex and half-duplex communication, and one or more UEs and/or repeater nodes may support half-duplex communication only. In another example, a repeater node may include an MT component that supports full-duplex and half-duplex communication and an FWD component that supports half-duplex communication only.

As shown in FIG. 4, examples 400 and 405 show examples of in-band full-duplex (IBFD) communication. In a scenario where a network node supports IBFD and a UE supports half-duplex communication only, the network node may receive an uplink communication from a first UE and may transmit a downlink communication to a second UE on the same time and frequency resources. As shown in example 400, in a first example of IBFD, the time and frequency resources for uplink communication may fully overlap with the time and frequency resources for downlink communication (e.g., all time and frequency resources allocated to uplink communication are also available for downlink communication). As shown in example 405, in a second example of IBFD, the time and frequency resources for uplink communication may partially overlap with the time and frequency resources for downlink communication (e.g., some time and frequency resources are reserved for uplink communication only).

As further shown in FIG. 4, example 410 shows an example of SBFD communication, which may also be referred to as “sub-band frequency division duplex (SBFDD),” “flexible duplex,” or “FDD in unpaired spectrum.” In some aspects, an SBFD communication mode may be supported by a network node only, by a network node and a UE, by a network node and a repeater node, and/or any suitable combination thereof. In the SBFD communication, a node operating in accordance with an SBFD configuration may simultaneously transmit and receive different communications at the same time, but on different frequency resources. For example, a network node operating in accordance with an SBFD configuration may simultaneously receive an uplink communication from a first UE in an uplink sub-band and transmit a downlink communication to a second UE in a downlink sub-band, where the uplink sub-band and the downlink sub-band may occupy different frequency resources. Similarly, when a UE supports an SBFD configuration, the UE may transmit an uplink communication to a network node and receive a downlink communication from the network node at the same time, but on different frequency resources. For example, the different frequency resources may be sub-bands of a frequency band, such as a TDD band. In this case, the frequency resources used for downlink communication may be separated from the frequency resources used for uplink communication, in the frequency domain, by a guard band.

As indicated above, FIG. 4 is provided as an example. Other examples may differ from what is described with regard to FIG. 4.

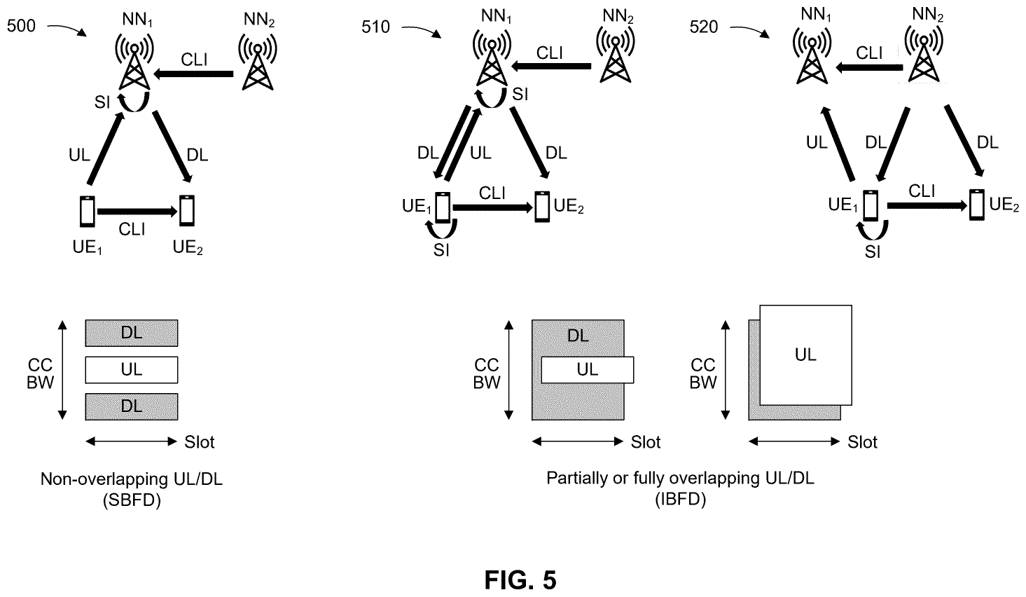

FIG. 5 is a diagram illustrating examples 500, 510, 520 of full-duplex deployment scenarios, in accordance with the present disclosure. As shown in FIG. 5, examples 500, 510, 520 include one or more UEs in communication with one or more network nodes in a wireless network that supports full-duplex communication. In general, as described herein, utilizing a full-duplexing communication mode may provide reduced latency by allowing a downlink transmission to occur in an uplink-only symbol or slot and/or by allowing an uplink transmission to occur in a downlink-only symbol or slot. In addition, full-duplex communication may enhance spectral efficiency or throughput per cell or per UE and/or enable more efficient resource utilization by simultaneously utilizing time and frequency resources for downlink and uplink communication. However, as described in further detail herein, full-duplexing communication modes may be associated with dynamic interference conditions.

For example, as shown in FIG. 5, example 500 includes a first UE (shown as UE₁) and a second UE (shown as UE₂) in communication with a first network node (shown as NN₁) operating in a full-duplexing mode, with the first UE and the second UE operating in a half-duplexing mode. For example, as shown in FIG. 5, the first UE may transmit one or more uplink transmissions to the first network node, and the second UE may concurrently receive one or more downlink transmissions from the first network node. Accordingly, in example 500, the first network node is operating in a full-duplexing mode, and the first UE and the second UE are each operating in a half-duplexing mode. As shown by example 500, there may be various forms of interference that may degrade downlink reception performance at one or more UEs and/or uplink reception performance at the first network node operating in the full-duplexing mode.

For example, as shown, the first network node may experience cross-link interference (CLI) caused by downlink transmissions from a second network node (shown as NN₂) that may be located in an adjacent or nearby cell. Furthermore, as shown, the uplink transmission from the first UE to the first network node may cause CLI at the second UE (e.g., CLI that interferes with downlink reception at the second UE). Furthermore, as shown, the first network node may experience self-interference, where the downlink transmission to the second UE interferes with reception of the uplink transmission from the first UE. For example, as described herein, self-interference may generally occur when a transmitted signal leaks into a receive port and/or when an object in a surrounding environment reflects a transmitted signal back to a receive port (e.g., causing a clutter echo effect), thus interfering with reception of a desired signal at the receive port. In general, the full-duplexing mode used by the first network node in example 500 may be an SBFD mode, where a component carrier bandwidth is divided into one or more uplink sub-bands and one or more downlink sub-bands that are separated by one or more guard bands.

As further shown in FIG. 5, in example 510, a first UE may communicate with a first network node in a full-duplexing mode. For example, in example 510, the first UE may receive one or more downlink transmissions from the first network node, and the first UE may concurrently transmit one or more uplink transmissions to the first network node. Accordingly, in example 510, the first network node and the first UE are both operating in a full-duplexing mode. Furthermore, as shown, the first network node may be communicating with a second UE operating in a half-duplex mode. As shown by example 510, the first UE may experience self-interference, where the uplink transmission to the first network node interferes with reception of the downlink transmission from the first network node, and the first UE may cause cross-link interference at the second UE, where the uplink transmission to the first network node interferes with downlink reception at the second UE. Additionally, in example 510, the first network node may experience CLI caused by one or more downlink transmissions from a second network node interfering with reception of the uplink transmission from the first UE, and the first network node may experience self-interference, where downlink transmission(s) to the first UE and/or the second UE interferes with reception of the uplink transmission from the first UE. In example 510, the full-duplex communication may be performed in an SBFD mode, where a component carrier bandwidth is divided into non-overlapping uplink and downlink sub-bands, or in an IBFD mode, where uplink and downlink resources fully or partially overlap.

As further shown in FIG. 5, in example 520, a first UE may communicate with a first network node and a second network node in a full-duplexing mode (e.g., a multi-TRP mode). For example, in example 520, the first UE may transmit one or more uplink transmissions to the first network node, and the first UE may concurrently receive one or more downlink transmissions from the second network node. Accordingly, in example 520, the first UE is operating in a full-duplexing mode, and the first and second network nodes are both operating in a half-duplexing mode. As shown by example 520, the first UE may experience self-interference, where the uplink transmission to the first network node interferes with reception of the downlink transmission from the second network node. Furthermore, the uplink transmission by the first UE may cause CLI at a second UE that is receiving a downlink transmission from the second network node.

Furthermore, as shown, the downlink transmission by the second network node may cause CLI interfering with reception of the uplink transmission from the first UE at the first network node. In example 520, the full-duplex communication may be performed in an SBFD mode, where a component carrier bandwidth is divided into non-overlapping uplink and downlink sub-bands, or in an IBFD mode, where uplink and downlink resources fully or partially overlap.

As indicated above, FIG. 5 is provided as an example. Other examples may differ from what is described with regard to FIG. 5.

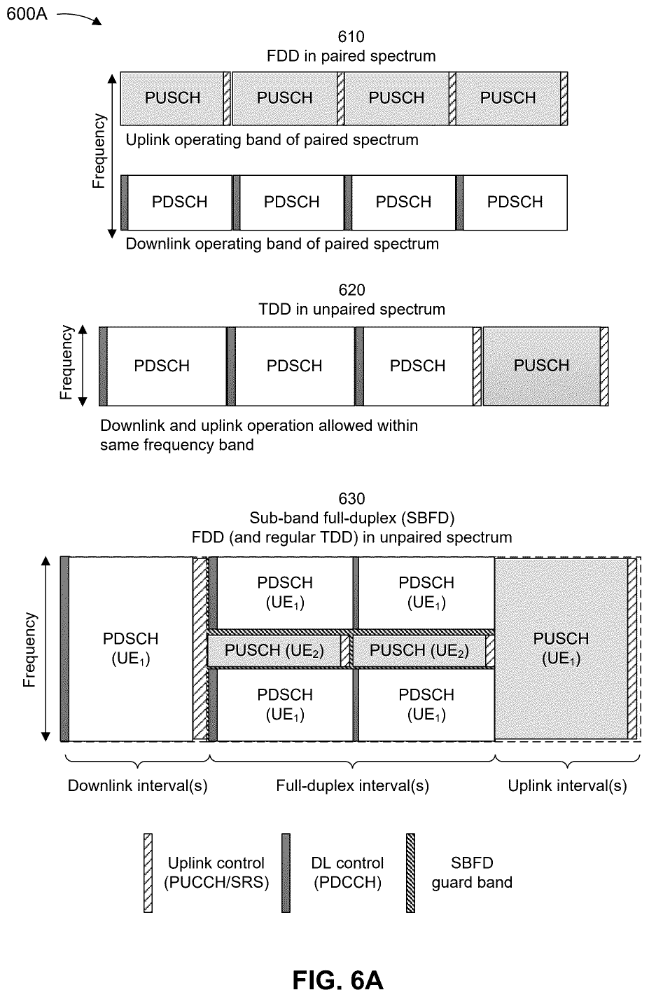

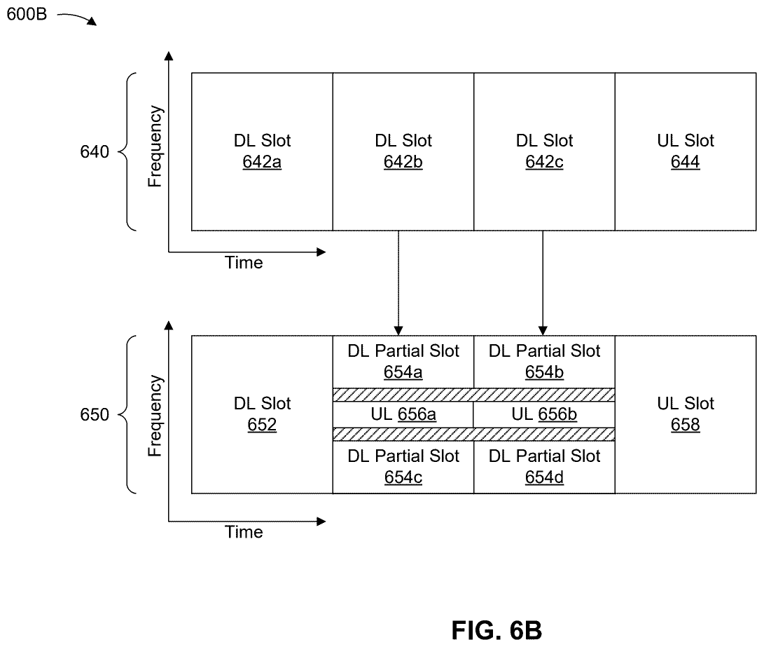

FIG. 6A is a diagram illustrating examples 600 of different duplexing modes, and FIG. 6B is a diagram illustrating an example 600B of SBFD activation, in accordance with the present disclosure. For example, as described in further detail herein, FIG. 6A illustrates an example 610 of an FDD mode that may be used in paired spectrum, an example 620 of a TDD mode that may be used in unpaired spectrum, and an example 630 of an SBFD mode that may be used in unpaired spectrum, and FIG. 6B illustrates an example 600B of techniques that may be used to activate the SBFD mode.

In some aspects, a wireless communication standard and/or governing body may generally specify one or more duplexing modes in which a wireless spectrum is to be used. For example, 3GPP may specify how wireless spectrum is to be used for the 5G/NR radio access technology and interface. As an example, a specification may indicate whether a band is to be used as paired spectrum in an FDD mode or as unpaired spectrum in a TDD mode.

For example, as shown by example 610, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a network node or a UE with full-duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP Technical Specification (TS) 38.101-1.

Alternatively, as shown by example 620, unpaired spectrum in the TDD mode may allow downlink and uplink operation within a single frequency region (e.g., a single operating band). For example, when operating in TDD mode in unpaired spectrum, downlink communication and uplink communication may occur in the same frequency range. Some deployments may use TDD in the unpaired band, whereby some transmission time intervals (e.g., frames, slots, and/or symbols) are used for downlink communication only and other transmission time intervals are used for uplink communication only. In this case, substantially the entire bandwidth of a component carrier may be used for downlink communication or uplink communication, depending on whether the communication is performed in a downlink interval, an uplink interval, or a special interval (in which either downlink or uplink communication can be scheduled). Examples of unpaired bands include NR operating bands n40, n41, and n50, as specified by 3GPP TS 38.101-1. In some cases, however, using TDD in unpaired spectrum may be inefficient. For example, uplink transmit power may be limited, meaning that UEs may be incapable of transmitting with enough power to efficiently utilize the full bandwidth of an uplink slot. This may be particularly problematic in large cells at the cell edge. Furthermore, using TDD may introduce latency relative to a full-duplex scheme in which uplink communications and downlink communications can be performed in the same time interval, because TDD restricts usage of a given transmission time interval to uplink or downlink communication only. Furthermore, using TDD may reduce spectral efficiency and/or reduce throughput by restricting usage of a given transmission time interval to uplink or downlink communication only.

Accordingly, as shown by example 630, an unpaired band may be configured in a full-duplexing mode to enable concurrent transmit and receive operations in unpaired spectrum (e.g., a TDD band). For example, in FIG. 6A, example 630 depicts an SBFD mode, which may be referred to herein as full-duplexing in a frequency division multiplexing (FDM) mode or using other suitable terminology, in order to enable TDD operation and/or FDD operation in unpaired spectrum. For example, as shown in FIG. 6A, an unpaired band configured in the SBFD mode may associate one or more transmission time intervals with downlink communication only (e.g., “D” slots), one or more transmission time intervals for uplink communication only (e.g., “U” slots), and one or more transmission time intervals for both downlink communication and uplink communication (e.g., “D+U” slots). Each transmission time interval may be associated with a control region, illustrated as a portion of a time interval with a diagonal fill for uplink control (e.g., a PUCCH) or a darker-shaded fill for downlink control (e.g., a PDCCH). Additionally, or alternatively, each time interval may be associated with a data region, which is shown as a PDSCH for downlink frequency regions or a PUSCH for uplink frequency regions.

In some aspects, an unpaired band configured in the SBFD mode may include one or more downlink-only time intervals, one or more uplink-only time intervals, and/or one or more full-duplex time intervals (e.g., frames, subframes, slots, and/or symbols, among other examples) that are associated with an FDD configuration. For example, as shown in FIG. 6A, the FDD configuration associated with a full-duplex time interval may indicate one or more downlink frequency regions (or sub-bands) and one or more uplink frequency regions (or sub-bands) that are separated by a guard band. Accordingly, an FDD configuration may divide an unpaired frequency band (e.g., one or more component carriers of an unpaired band) into uplink frequency regions, downlink frequency regions, and/or other regions (e.g., guard bands and/or the like), which may enable a network node or a UE with full-duplex capabilities to perform simultaneous transmit and receive operations during one or more time intervals that are divided into downlink and uplink sub-bands with a guard band separation to prevent the uplink transmission from causing self-interference with respect to downlink reception. For example, in a given full-duplex time interval, a half-duplexing UE may either transmit using the uplink frequency region or receive in the downlink frequency region (e.g., a UE communicating in a half-duplexing mode may only receive in a downlink frequency region or transmit in an uplink frequency region during the full-duplex time intervals). Alternatively, a full-duplexing UE may transmit using the uplink frequency region and/or receive in the downlink frequency region. Additionally, or alternatively, a full-duplexing network node may transmit a downlink communication to a first UE within the downlink frequency regions(s) and simultaneously receive an uplink communication from a second UE in the uplink frequency region(s). In some aspects, the FDD configuration may identify BWP configurations corresponding to the uplink frequency regions and the downlink frequency regions. For example, a respective BWP may be configured for each uplink frequency region and each downlink frequency region.

Additionally, or alternatively, full-duplexing may be enabled in unpaired spectrum in an IBFD mode, which may be referred to herein as full-duplexing in a spatial division multiplexing (SDM) mode. For example, in an IBFD or SDM mode, uplink communication may occur on time and frequency resources that fully overlap time and frequency resources allocated to downlink communication (e.g., all of the time and frequency resources available for uplink communication are also available for downlink communication), or time and frequency resources that partially overlap with time and frequency resources available for downlink communication (e.g., some time and frequency resources available for uplink communication are also available for downlink communication and some time and frequency resources available for uplink communication are uplink-only). In general, in the IBFD mode, full-duplex communication may be conditional on sufficient beam separation between an uplink beam and a downlink beam (e.g., uplink transmission may be from one antenna panel and downlink reception may be in another antenna panel) in order to minimize self-interference that may occur when a transmitted signal leaks into a receive port and/or when an object in a surrounding environment reflects a transmitted signal back to a receive port (e.g., causing a clutter echo effect).

In some cases, as described herein, one or more frequency regions that support SBFD communication may be configured to dynamically switch between operating in a TDD mode and an SBFD mode. For example, as shown in FIG. 6B, example 600B includes a first configuration 640 (e.g., a legacy or default configuration associated with the TDD mode). In some aspects, the first configuration 640 may indicate a first slot format pattern (sometimes called a TDD pattern) associated with a half-duplex mode (e.g., where each interval is downlink-only or uplink-only). The first slot format pattern may include one or more downlink intervals (e.g., shown as three downlink slots 642a, 642b, and 642c, although each downlink interval may correspond to a downlink symbol or another suitable transmission time interval for downlink communication), one or more flexible intervals (not shown), and/or one or more uplink intervals (e.g., shown as one uplink slot 644, although each uplink interval may correspond to an uplink symbol or another suitable transmission time interval for uplink communication). The first slot format pattern may repeat over time. In some aspects, a network node 110 may indicate the first slot format pattern to a UE 120 using one or more slot format indicators. A slot format indicator, for a slot, may indicate whether the corresponding slot is an uplink slot, a downlink slot, or a flexible slot (e.g., that can be used as an uplink or downlink slot).

A network node 110 may instruct (e.g., using an indication, such as an RRC message, a MAC-CE, or DCI) a UE 120 to switch from the first configuration 640 to a second configuration 650. As an alternative, the UE 120 may indicate to the network node 110 that the UE 120 is switching from the first configuration 640 to the second configuration 650. The second configuration 650 may indicate a second slot format pattern that repeats over time, similar to the first slot format pattern. In any of the aspects described above, the UE 120 may switch from the first configuration 640 to the second configuration 650 during a time period (e.g., a quantity of symbols and/or an amount of time (e.g., in ms)) based at least in part on an indication received from the network node 110 (e.g., before switching back to the first configuration 640). During that time period, the UE 120 may communicate using the second slot format pattern, and then may revert to using the first slot format pattern after the end of the time period. The time period may be indicated by the network node 110 (e.g., in the instruction to switch from the first configuration 640 to the second configuration 650, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by p and associated with corresponding SCSs) with corresponding time periods for switching configurations.

In example 600B, the second slot format pattern includes two SBFD slots in place of what were downlink slots in the first slot format pattern. In example 600B, the second slot format pattern includes a downlink slot 652, which is followed by one or more SBFD slots that each include a partial slot (e.g., a portion or sub-band of a frequency allocated for use by the network node 110 and the UE 120) for downlink (e.g., partial slots 654a, 654b, 654c, and 654d, as shown) and a partial slot for uplink (e.g., partial slots 656a and 656b, as shown), which are followed by an uplink slot 658. Accordingly, the UE 120 may operate using the second slot format pattern to transmit an uplink communication in an earlier slot (e.g., the second slot in sequence, shown as partial uplink slot 656a) as compared to using the first slot format pattern (e.g., the fourth slot in sequence, shown as uplink slot 644). Other examples may include additional or alternative changes. For example, the second configuration 650 may indicate an SBFD slot in place of what was an uplink slot in the first configuration 640 (e.g., uplink slot 644). In another example, the second configuration 650 may indicate a downlink slot or an uplink slot in place of what was an SBFD slot in the first configuration 640 (not shown in FIG. 6B). In yet another example, the second configuration 650 may indicate a downlink slot or an uplink slot in place of what was an uplink slot or a downlink slot, respectively, in the first configuration 640. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 6B). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full duplex (FD) mode in one or more slots based at least in part on the one or more slots having the SBFD format. A slot may support the SBFD mode if an uplink bandwidth part and a downlink bandwidth part are permitted to be or are simultaneously active in the slot in an SBFD fashion (e.g., with guard band separation).

By switching from the first configuration 640 to the second configuration 650, the network node 110 and the UE 120 may experience increased quality and/or reliability of communications. For example, the network node 110 and the UE 120 may experience increased throughput (e.g., using a full-duplex mode), reduced latency (e.g., the UE 120 may be able to transmit an uplink and/or a downlink communication sooner using the second configuration 650 rather than the first configuration 640), and increased network resource utilization (e.g., by using both the downlink bandwidth part and the uplink bandwidth part simultaneously instead of only the downlink bandwidth part or the uplink bandwidth part).

As indicated above, FIG. 6 is provided as an example. Other examples may differ from what is described with regard to FIG. 6.

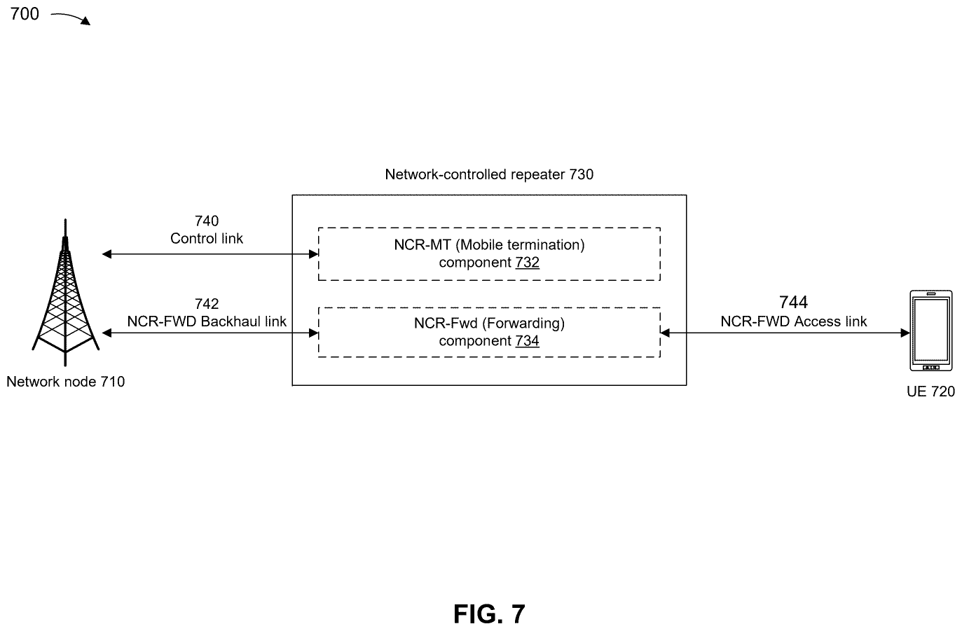

FIG. 7 is a diagram illustrating an example 700 of an NCR, in accordance with the present disclosure. In some aspects, as shown in FIG. 7, example 700 includes an NCR node 730 that may be configured to forward communications between a network node 710 and a UE 720 in a wireless network. As shown in FIG. 7, the NCR node 730 may include an MT component 732 (shown as NCR-MT component) that may communicate with the network node 710 over a control link 740 and an FWD component 734 (shown as NCR-FWD component) that may communicate with the network node 710 over a backhaul link 742 (shown as NCR-FWD backhaul link) and with the UE 720 over an access link 744 (shown as NCR-FWD access link). In some aspects, the network node 710 may be the network node 110, the CU 310, and/or the DU 330 described herein. Furthermore, the UE 720 may be the UE 120 described herein, and the NCR node 730 may be the relay network node 110d and/or the RU 340 described herein

Accordingly, as described herein, the NCR-FWD component 734 of the NCR node 730 may be configured to receive, from the network node 710, a downlink access link transmission (for example, a PDCCH or a PDSCH) directed to the UE 720 via the NCR-FWD backhaul link 742, and may forward (for example, transmit a regenerated version of) the downlink access link transmission to the UE 720 via the NCR-FWD access link 744. In addition, the NCR-FWD component 734 of the NCR node 730 may be configured to receive, from the UE 720, an uplink access link transmission (for example, a PUCCH or a PUSCH) directed to the network node 710 via the NCR-FWD access link 744, and may forward (for example, transmit a regenerated version of) the uplink access link transmission to the network node 710 via the NCR-FWD backhaul link 742. Accordingly, as shown, an access link connection between the network node 710 and the UE 720 may include downlink traffic and uplink traffic that is routed through the NCR-FWD component 734 of the NCR node 730. For example, as described herein, the NCR-MT component 732 may communicate with the network node 710 via the control link 740, which may have a similar configuration as a Uu interface in an NR network, to exchange side control information.

Furthermore, the NCR-FWD component 734 may be configured to perform amplify-and-forward processing to repeat a downlink RF signal that is received from the network node 710 via the NCR-FWD backhaul link 742 and/or to repeat an uplink RF signal that is received from the UE 720 via the NCR-FWD access link 744. In some aspects, as described herein, various behaviors of the NCR-FWD component 734 may be controlled according to the side control information that the NCR-MT component 732 receives from the network node 710 via the control link 740. For example, as described herein, the side control information may include a reception configuration, a buffering configuration, a forwarding configuration, an information request, and/or any other suitable configuration or control information related to forwarding RF signals between the network node 710 and the UE 720. In some aspects, as described herein, the NCR node 730 may be configured as an in-band RF repeater to extend coverage in one or more frequency bands or frequency ranges (for example, in FR1 and/or FR2), and may be deployed in a single-hop stationary configuration that is transparent to the UE 720 (for example, there is only one NCR node 730 between the network node 710 and the UE 720, and the NCR node 730 is not moving or otherwise changing locations). Furthermore, in some aspects, the NCR node 730 may simultaneously maintain a first link with the network node 710 and a second link with the UE 720 such that RF signals can be repeated by the NCR node 730 with low additional latency.

In some cases, as described herein, full-duplex communication may be enabled in a wireless network to improve performance (e.g., by reducing latency, increasing spectral efficiency, or the like). For example, a network node 710 may support an SBFD communication mode, where the network node 710 may receive an uplink communication from a first UE 720 and transmit a downlink communication to a second UE 720 at the same time using different frequency resources (e.g., downlink and uplink sub-bands). However, in some network deployments, the SBFD communication mode may be supported only by the network node 710, with other nodes such as UEs 720 and NCR nodes 730 being limited to TDD or half-duplex operation (e.g., only transmitting or only receiving in any particular transmission time interval). For example, an NCR node 730 typically uses semi-static TDD information that a (controlling) network node 710 provides to the MT component 732 of the NCR node 730 to determine a forwarding direction (downlink or uplink) to be used by the FWD component 734 of the NCR node 730 in each symbol or slot. Although an FWD component 734 of an NCR node 730 may be limited to half-duplex operation, providing an NCR node 730 with information related to an SBFD configuration associated with a network node 710 may allow the NCR node 730 to adjust operations within one or more SBFD symbols and/or non-SBFD symbols to improve forwarding services used to extend the coverage of the network node 710.

For example, as described herein, an NCR node 730 may be provided with information that indicates the SBFD configuration associated with a network node 710 and indicates whether the repeater node is to forward communications in an uplink direction or a downlink direction within one or more SBFD symbols. For example, in some aspects, the network node 710 may provide the repeater node with a semi-static indication of the SBFD configuration used by the network node 710, which may indicate SBFD time resources (e.g., SBFD symbols or SBFD slots) and/or SBFD sub-band configurations. Furthermore, the forwarding direction to be used in the SBFD symbols may be indicated dynamically or semi-statically, and the forwarding direction may be common to all SBFD symbols or may be indicated granularly (e.g., with different forwarding directions to be used in different sets or subsets of SBFD symbols). Additionally, or alternatively, the forwarding direction may be implicitly indicated according to one or more configurations or rules, or based on an implementation of the NCR node 730. Furthermore, some aspects described herein relate to forwarding operations that may be used by the NCR node 730 based on a sub-band filtering capability of the repeater node, SBFD configuration indications that may be based on an SBFD configuration provided for an SBFD-capable MT component 732 of the NCR node 730, different communication configurations to be used in SBFD and/or non-SBFD symbols, and/or techniques to apply the SBFD configuration associated with a network node 710 for an NCR node 730 having bi-directional forwarding capabilities.

As indicated above, FIG. 7 is provided as an example. Other examples may differ from what is described with regard to FIG. 7.

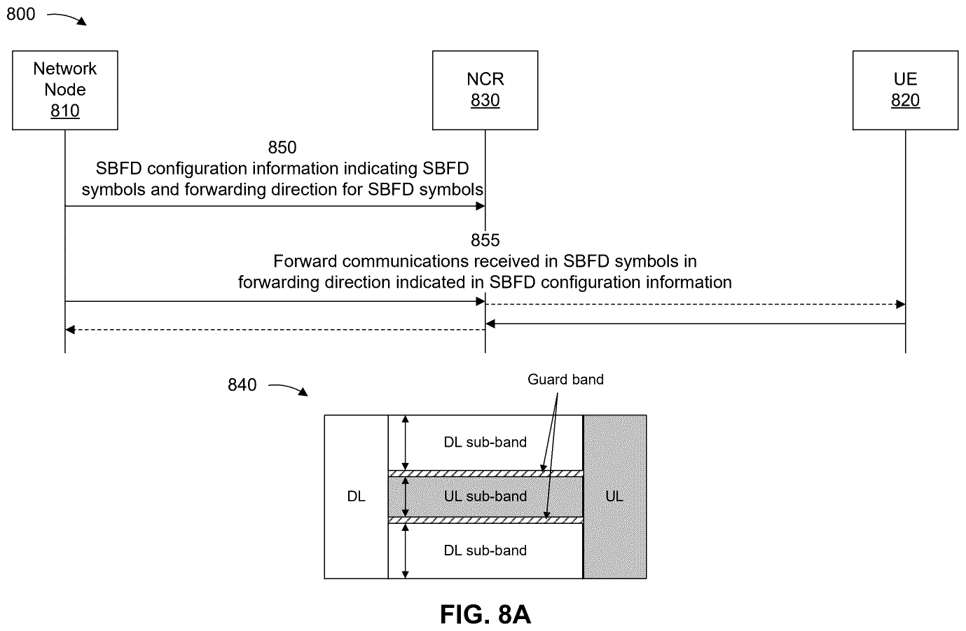

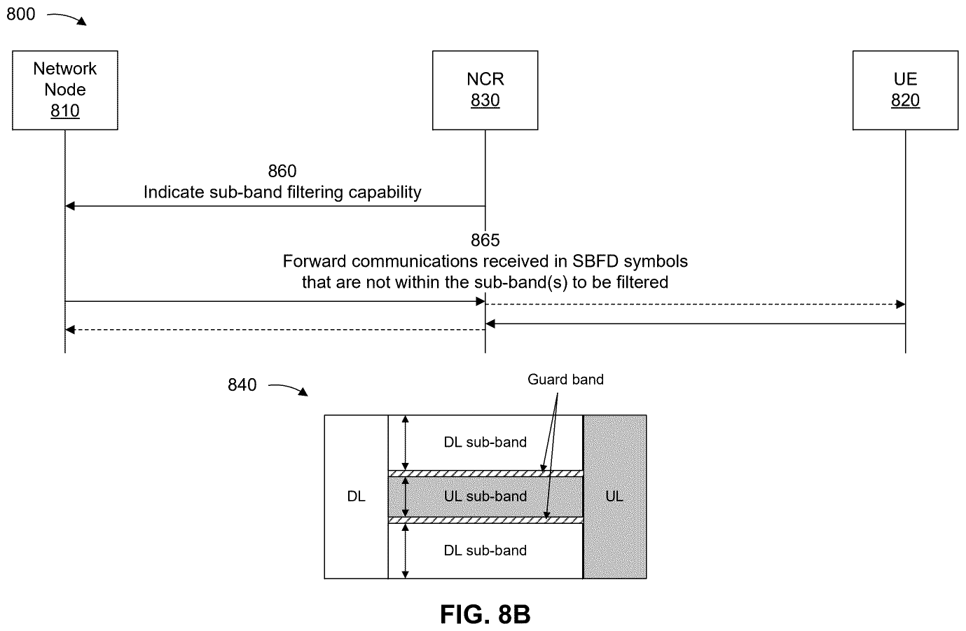

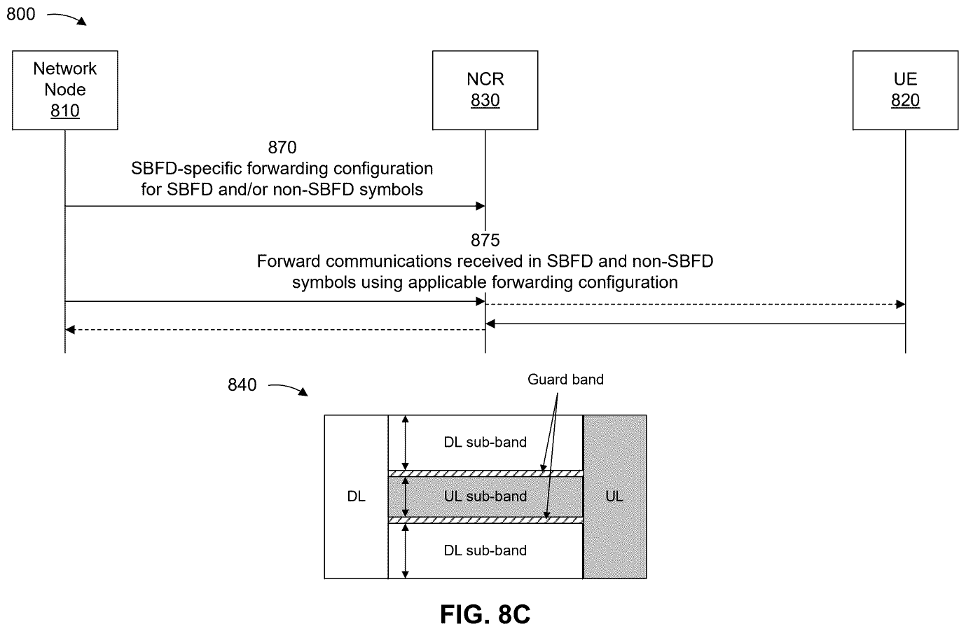

FIGS. 8A-8C are diagrams illustrating examples associated with SBFD awareness for an NCR, in accordance with the present disclosure. As shown in FIGS. 8A-8C, examples 800 includes communication between a network node 810, an NCR node 830 (e.g., a repeater node that is controlled by the network node 810), and a UE 820. In some aspects, the network node 810 may correspond to the network node 110, the CU 310, the DU 340, the RU 340, and/or the network node 710 described herein, the NCR node 830 may correspond to the repeater network node 110d, the DU 330, the RU, and/or the NCR node 830 described herein, and the UE 820 may correspond to the UE 120 and/or the UE 720 described herein. In some aspects, the network node 810, the UE 820, and the NCR node 830 may be included in a wireless network, such as wireless network 100. The network node 810 and the UE 820 may communicate via a wireless access link, which may include an uplink and a downlink.

Furthermore, the NCR node 830 may include an MT component (not shown in FIGS. 8A-8C) and an FWD component (not shown in FIGS. 8A-8C). For example, the MT component of the NCR node 830 may communicate with the network node 810 over a control link to exchange control information related to forwarding operations performed by the FWD component of the NCR node 830, and the FWD component may forward communications in an uplink direction and/or a downlink direction in accordance with the control information received by the MT component. For example, when the control information configures the NCR node 830 to perform forwarding operations in a downlink direction, the NCR node 830 may receive one or more downlink communications from the network node 810 (e.g., PDCCH transmissions, PDSCH transmissions, downlink reference signal transmissions, or the like) over a backhaul link, and may forward the one or more downlink communications to the UE 820 over an access link. Additionally, or alternatively, when the control information configures the NCR node 830 to perform forwarding operations in an uplink, the NCR node 830 may receive one or more uplink communications from the UE 820 (e.g., PUCCH transmissions, PUSCH transmissions, uplink reference signal transmissions, or the like) over the access link, and may forward the one or more uplink communications to the network node 810 over the backhaul link.

In some aspects, as shown in FIGS. 8A-8C, and by reference number 840, the network node 810 may be configured to operate in an SBFD communication mode, where an unpaired (e.g., TDD) band includes one or more symbols that are configured in a full-duplexing mode to enable concurrent transmit and receive operations in the unpaired (e.g., TDD) band. For example, as described herein, an unpaired (e.g., TDD) band that is configured in the SBFD mode may include one or more time resources that are dedicated to downlink communication (e.g., downlink-only slots or symbols), one or more time resources that are dedicated to uplink communication (e.g., uplink-only slots or symbols), and one or more time resources (e.g., SBFD slots or symbols) that support full-duplex (e.g. simultaneous downlink and uplink) communication. For example, as shown in FIGS. 8A-8C and described in more detail elsewhere herein, the one or more time resources that support SBFD communication may partition frequency resources within a TDD band into one or more downlink sub-bands, and up to one uplink sub-band may be used to support SBFD operation in the one or more time resources that support SBFD communication (e.g., excluding any legacy uplink symbols) within a TDD carrier, with one or more guard bands separating the downlink sub-band(s) from the uplink sub-band. For example, in FIGS. 8A-8C, reference number 840 corresponds to an SBFD configuration in which the bandwidth of a TDD carrier is partitioned, within one or more SBFD time resources, into a first downlink sub-band spanning a first (lower) frequency, a second downlink sub-band spanning a second (higher) frequency, and an uplink sub-band spanning a frequency between the first downlink sub-band and the second downlink sub-band. In addition, as further shown by reference number 840, the bandwidth of the TDD carrier may include first guard band separating the first downlink sub-band from the uplink sub-band and a second guard band separating the second downlink sub-band from the uplink sub-band.

As described herein, some aspects relate to SBFD configurations where the downlink-only, uplink-only, and SBFD time resources are symbol-level resources. However, some aspects described herein may be similarly applied in wireless network deployments where the downlink-only, uplink-only, and SBFD time resources are slot-level resources or associated with other suitable transmission time intervals. Furthermore, some aspects described herein relate to wireless network deployments where only the network node 810 supports SBFD operation, with the UE 820 and the NCR node 830 limited to TDD half-duplex operation. For example, in cases where the NCR node 830 is limited to TDD half-duplex operation, the NCR node 830 may forward signals in only a downlink direction or only an uplink direction within each symbol, slot, or other transmission time interval in order to help extend the coverage of the network node 710. In some aspects, as described herein, the NCR node 830 may receive information related to an SBFD configuration of the network node 710 such that that the NCR node 830 can improve forwarding services that are used to extend the coverage of the network node 710. Additionally, or alternatively, some aspects described herein relate to wireless network deployments where the network node 810 and one or more components of the NCR node 830 support SBFD operation (e.g., the MT component of the NCR node 830 may have SBFD capabilities for one or more component carriers that are used to communicate with the network node 810 over the control link, and/or the FWD component of the NCR node 830 may have bi-directional forwarding capabilities to enable concurrent forwarding in uplink and downlink directions within an SBFD symbol, slot, or other time resource). In such cases, the UE 820 may support full-duplex (e.g., SBFD) operation or may support only TDD half-duplex operation. In any case, the UE 820 may be aware of the SBFD configuration of the network node 810 (and the NCR node 830, if the NCR is SBFD-capable) and may adjust scheduling, measurement, and/or other operations within the SBFD time resources in accordance with the SBFD configuration of the network node 810. Furthermore, in some cases, various options may be configured to support downlink communication within uplink sub-bands and/or to support uplink communication within downlink sub-bands associated with one or more time resources allocated to SBFD communication.

For example, as shown in FIG. 8A, and by reference number 850, the network node 810 may send, and the NCR node 830 may receive, SBFD configuration information associated with the network node 810. For example, in some aspects, the SBFD configuration information associated with the network node 810 may be provided (e.g., to the MT component of the NCR node 830) semi-statically (e.g., via RRC signaling or another suitable semi-static indication). Furthermore, in some aspects, the SBFD configuration may indicate time resources in which the network node 810 communicates in an SBFD mode (e.g., one or more SBFD slots, SBFD symbols, and/or other SBFD time resources in which the network node 810 supports simultaneous uplink and downlink communication within a TDD carrier). Additionally, or alternatively, the SBFD configuration information other suitable information related to the SBFD time resources, such as a periodicity or a duty cycle. Furthermore, in some aspects, the SBFD configuration information may further indicate an SBFD sub-band configuration (e.g., a frequency domain configuration) within the time resources in which the network node 810 communicates in an SBFD mode. For example, the SBFD sub-band configuration may indicate frequency resources associated with one or more downlink sub-bands, frequency resources associated with one or more uplink sub-bands, and frequency resources associated with one or more guard bands that separate the downlink and uplink sub-bands. For example, the frequency resources may indicate one or more resource blocks (RBs) and/or resource elements (REs) allocated to the one or more downlink sub-bands, the one or more uplink sub-bands, and/or the one or more guard bands.

In some aspects, as further shown in FIG. 8A, and by reference number 850, the network node 810 may send, and the NCR node 830 may receive, information that indicates or configures a forwarding direction for the NCR node 830 in one or more SBFD time resources. Additionally, or alternatively, the network node 810 may send, and the NCR node 830 may receive, information that indicates or configures one or more sub-bands in which the NCR node 830 is to forward communications in one or more SBFD time resources (e.g., an uplink sub-band in which the NCR node 830 is to forward communications in an uplink direction in the one or more SBFD time resources, a downlink sub-band in which the NCR node 830 is to forward communications in a downlink direction in the one or more SBFD time resources, or the like). For example, in cases where the NCR node 830 is configured in a TDD mode such that NCR node 830 forwards in a downlink direction only or an uplink direction only within each symbol, slot, or other time resource, the network node 810 may send control information (e.g., to the MT component) to configure the NCR node 830 to forward communications in a downlink direction or an uplink direction in one or more SBFD time resources. Additionally, or alternatively, in cases where the NCR node 830 has a wideband bi-directional forwarding capability such that NCR node 830 can simultaneously forward in downlink and uplink directions, the network node 810 may send control information (e.g., to the MT component) to configure the NCR node 830 to forward communications in a downlink direction, an uplink direction, or both the downlink direction and the uplink direction in the one or more SBFD time resources. In either case, the indication or configuration of the forwarding direction may be common to all SBFD time resources (e.g., the NCR node 830 forwards in the downlink direction only, the uplink direction only, or both the downlink direction and the uplink direction in each SBFD time resource), or the indication or configuration of the forwarding direction may be provided for different sets of SBFD symbols. For example, in cases where the forwarding direction is indicated or configured for different sets of SBFD symbols, the NCR node 830 may be configured to forward in a downlink direction only for a set of SBFD symbols, in an uplink direction only for a set of SBFD symbols, in the downlink direction and the uplink direction for a set of SBFD symbols, and/or any suitable combination thereof.

In some aspects, the network node 810 may explicitly indicate the forwarding direction and/or the sub-bands in which the NCR node 830 is to forward communications in the SBFD time resources using dynamic signaling (e.g., using one or more DCI messages or other dynamic signaling) and/or using semi-static signaling (e.g., using one or more RRC messages or other semi-static signaling). Additionally, or alternatively, the forwarding direction and/or the sub-bands in which the NCR node 830 is to forward communications in the SBFD time resources may be indicated implicitly according to one or more rules, configurations, conditions, or other suitable parameters. For example, in some aspects, the direction in which the NCR node 830 is to forward communications in the SBFD time resources may be implicitly indicated according to a legacy TDD configuration or TDD pattern associated with the TDD carrier in which SBFD communication is enabled. For example, as described elsewhere herein, SBFD communication may be enabled in a TDD carrier associated with a legacy TDD pattern that indicates one or more downlink time resources, one or more uplink time resources, and one or more flexible resources that repeat in a time domain according to a configured periodicity. Furthermore, when SBFD communication is enabled in the TDD carrier, an SBFD pattern may be configured to indicate one or more time resources in which the frequency resources of the TDD pattern are partitioned into downlink and uplink sub-bands to support full-duplex operation. Accordingly, in such cases, the NCR node 830 may implicitly determine the forwarding direction within an SBFD time resource based on the downlink or uplink configuration of the underlying SBFD time resource within the legacy TDD pattern. For example, the NCR node 830 may forward communications in a downlink direction within any SBFD time resources that correspond to legacy downlink time resources and may forward communications in an uplink direction within any SBFD time resources that correspond to legacy uplink time resources. Alternatively, the NCR node 830 may use other suitable rules within SBFD time resources that correspond to legacy flexible time resources (e.g., any one or more of the rules described in further detail below).

Additionally, or alternatively, the direction in which the NCR node 830 is to forward communications in the SBFD time resources may be implicitly indicated according to a semi-static or dynamic TDD state associated with one or more non-SBFD time resources that are adjacent to the SBFD time resources. For example, in cases where the NCR node 830 is scheduled to forward communications over a set of consecutive symbols that includes one or more SBFD time resources that are preceded or followed by one or more non-SBFD time resources, the NCR node 830 may forward communications in the same direction (e.g., uplink only, downlink only, or both downlink and uplink) in the one or more SBFD time resources as the one or more non-SBFD time resources that precede or follow the one or more SBFD time resources. Additionally, or alternatively, the forwarding direction used by the NCR node 830 in the SBFD time resources may depend on an operating state or schedule of the MT component associated with the NCR node 830. For example, in cases where the MT component associated with the NCR node 830 is active in a downlink direction or an uplink direction in one or more time resources that fully or partially overlap with the SBFD time resources, the FWD component associated with the NCR node 830 may use the same forwarding direction as the MT component in the overlapping time resources. Additionally, or alternatively, the forwarding direction of the NCR node 830 may be based on an implementation of the NCR node 830 (e.g., based on energy detection within the downlink and/or uplink sub-bands within the SBFD time resources, where the NCR node 830 forwards a signal based on an energy level or input power measured in a downlink or uplink sub-band indicating the presence of the signal in an SBFD symbol).

Accordingly, as further shown in FIG. 8A, and by reference number 855, the NCR node 830 may forward one or more communications that are received in SBFD time resources in the forwarding direction that is explicitly or implicitly indicated in the manner described above. For example, in cases where the NCR node 830 is configured to forward in a downlink direction only within an SBFD time resource, the NCR node 830 may forward any downlink communications that are received from the network node 810 within an SBFD time resource to the UE 820 (and may filter out or otherwise discard any uplink communications that are received from the UE 820 within the SBFD time resource in which the NCR node 830 forwards in a downlink direction only). Alternatively, in cases where the NCR node 830 is configured to forward in an uplink direction only within an SBFD time resource, the NCR node 830 may forward any uplink communications that are received from the UE 820 within an SBFD time resource to the network node 810 (and may filter out or otherwise discard any downlink communications that are received from the network node 810 within the SBFD time resource in which the NCR node 830 forwards in the uplink direction only). Alternatively, in cases where the NCR node 830 has a bi-directional forwarding capability and is configured to forward in downlink and uplink directions within an SBFD time resource, the NCR node 830 may forward any uplink communications that are received from the UE 820 within an SBFD time resource to the network node 810 and may also forward any downlink communications that are received from the network node 810 within an SBFD time resource to the UE 820.

In some aspects, as shown in FIG. 8B, the forwarding operations associated with the NCR node 830 may be configured within SBFD time resources according to a sub-band filtering capability associated with the NCR node 830. For example, in some cases, the NCR node 830 may perform wideband forwarding of analog signals that are within an operating bandwidth that encompasses one or more component carriers associated with the MT component of the NCR node 830. Alternatively, in some cases, the NCR node 830 may support sub-band filtering for one or more downlink sub-bands and/or one or more uplink sub-bands, in which case the NCR node 830 selectively forwards only signals that are within certain sub-bands and/or filters (without forwarding) signals that are within certain sub-bands. In this way, the sub-band filtering capability may improve performance at the network node 810 in the SBFD time resources, because wideband forwarding across an entire operating bandwidth may cause interference with uplink reception at the network node 810.

Accordingly, as shown in FIG. 8B, and by reference number 860, the NCR node 830 may transmit, to the network node 810, information that indicates a sub-band filtering capability of the NCR node 830 (e.g., whether the NCR node 830 supports filtering one or more downlink sub-bands and/or one or more uplink sub-bands). Additionally, or alternatively, an operations, administration, and management (OAM) entity (e.g., a core network entity) may indicate the sub-band filtering capability of the NCR node 830 to the network node 810. For example, the sub-band filtering capability of the NCR node 830 may be indicated to the network node 810 due to the “sandwich” configuration of the downlink and uplink sub-bands (e.g., where an uplink sub-band occupies frequency resources between a first downlink sub-band and a second downlink sub-band). For example, a downlink sub-band filter may need a U-shaped filter design based on the downlink/uplink/downlink sub-band configuration in SBFD time resources, which may result in a more challenging implementation relative to a narrowband uplink filter.

Accordingly, as described herein, the NCR node 830 is generally configured to forward communications in a downlink direction only or an uplink direction only in cases where the NCR node 830 supports only TDD half-duplex operation. However, in cases where the NCR node 830 supports downlink and/or uplink sub-band filtering, the NCR node 830 may be configured to only forward communications within the relevant downlink and/or uplink sub-bands (e.g., that are not within the filtering capability of the NCR node 830), and to filter, without forwarding, any communications that are within irrelevant downlink and/or uplink sub-bands (e.g., within the filtering capability of the NCR node 830). Alternatively, in cases where the NCR node 830 has a bi-directional forwarding capability and supports downlink and/or uplink sub-band filtering, the network node 810 may indicate or otherwise configure certain downlink and/or uplink sub-bands and associated downlink and/or uplink states that the NCR node 830 is to simultaneously forward within the SBFD time resources.

Accordingly, as further shown in FIG. 8B, and by reference number 865, the NCR node 830 may forward one or more communications that are received in SBFD time resources in the forwarding direction that is explicitly or implicitly indicated in the manner described above, based on the sub-band filtering capability of the NCR node 830. For example, in cases where the NCR node 830 is configured to forward in a downlink direction only within an SBFD time resource, the NCR node 830 may forward, to the UE 820, any downlink communications received from the network node 810 within an SBFD time resource if the downlink communications are received within a downlink sub-band that is not within a downlink sub-band filtering capability of the NCR node 830. Furthermore, the NCR node 830 may filter out or otherwise discard any uplink communications that are received from the UE 820 within the SBFD time resource in which the NCR node 830 forwards in a downlink direction only, and may filter without forwarding any downlink communications that are received from the network node 810 within a downlink sub-band that the NCR node 830 has a capability to filter. Alternatively, in cases where the NCR node 830 is configured to forward in an uplink direction only within an SBFD time resource, the NCR node 830 may forward, to the network node 810, any uplink communications received from the UE 820 within an SBFD time resource if the uplink communications are received within an uplink sub-band that is not within an uplink sub-band filtering capability of the NCR node 830. Furthermore, the NCR node 830 may filter out or otherwise discard any downlink communications that are received from the network node 810 within the SBFD time resource in which the NCR node 830 forwards in an uplink direction only, and may filter without forwarding any uplink communications that are received from the UE 820 within an uplink sub-band that the NCR node 830 has a capability to filter. Alternatively, in cases where the NCR node 830 has a bi-directional forwarding capability and sub-band filtering capabilities, the NCR node 830 may forward any uplink communications that are received from the UE 820 and any downlink communications that are received from the network node 810 in sub-bands that are not within the filtering capability of the NCR node 830, and may filter out without forwarding any uplink communications that are received from the UE 820 and any downlink communications that are received from the network node 810 in sub-bands that are within the filtering capability of the NCR node 830.

In some aspects, as described herein, the network node 810 may support dynamic SBFD, where SBFD time resources may be dynamically configured to be SBFD resources, downlink-only resources, or uplink-only resources (e.g., depending on whether current traffic demands are downlink-heavy, uplink-heavy, associated with a downlink latency requirement, associated with an uplink latency requirement, or the like). Accordingly, to support dynamic SBFD operation, where resources that support SBFD operation can be configured in a downlink-only mode, an uplink-only mode, or an SBFD mode, the network node 810 may dynamically indicate a downlink and/or uplink forwarding state associated with the resources that support SBFD operation.

For example, as shown in FIG. 8C, and by reference number 870, the network node 810 may provide the NCR node 830 with an SBFD-specific forwarding configuration to be used in one or more SBFD time resources, where the SBFD-specific forwarding configuration may indicate whether the NCR node 830 is to perform wideband downlink forwarding over the entire bandwidth of the TDD carrier that supports SBFD operation or wideband uplink forwarding over the entire bandwidth of the TDD carrier that supports SBFD operation. Additionally, or alternatively, the SBFD-specific forwarding configuration may indicate whether the NCR node 830 is to perform downlink forwarding in one or more sub-bands and/or uplink forwarding in one or more sub-bands. In such cases, the network node 810 may optionally further indicate one or more sub-bands in which the NCR node 830 is to perform downlink and/or uplink forwarding.

Additionally, or alternatively, as described herein, the SBFD-specific forwarding configuration provided to the NCR node 830 may be associated with configuration information that the network node 810 provides to an MT component of the NCR node 830. For example, as described herein, the MT component of the NCR node 830 includes one or more serving cells or component carriers that are used to support communication with the network node 810 over the control link, the control information provided to the MT component may indicate an SBFD configuration of the network node 810 for the one or more serving cells or component carriers associated with the MT component. Accordingly, in some aspects, the SBFD configuration information used by the FWD component of the NCR node 830 may correspond to the SBFD configuration information that the MT component of the NCR node 830 previously acquired from the network node 810 for the one or more serving cells or component carriers associated with the MT component. However, in some cases, the one or more serving cells or component carriers associated with the MT component may be a subset of the component carriers that the FWD component of the NCR node 830 is configured to forward. Alternatively, when the NCR node 830 is configured as an out-of-band repeater, the component carriers that the FWD component of the NCR node 830 is configured to forward may differ from one or more component carriers that are used to support communication between the MT component and the network node 810. Accordingly, in some aspects, the MT component of the NCR node 830 may be provided with an SBFD configuration of the network node 810 for one or more component carriers that are non-serving cells for the MT component and within the operating bandwidth of the FWD component. Additionally, or alternatively, the network node 810 may provide the MT component with a unified set of uplink and downlink sub-bands that represent a union of all component carriers supported by the MT component and the FWD component. In such cases, each sub-band may be referenced within the set using an index, which may be provided to the MT component in side control information and/or an indication for the forwarding operations of the FWD component.

Additionally, or alternatively, as described herein, the SBFD-specific forwarding configuration provided to the NCR node 830 may include one or more configurations that the NCR node 830 is to adopt in SBFD time resources, which the network node 810 may indicate to the NCR node 830 using semi-static (e.g., RRC) signaling or other suitable signaling. Additionally, or alternatively, the network node 810 may provide the NCR node 830 with a first set of configurations to be used in SBFD time resources and a second set of configurations to be used in non-SBFD time resources (e.g., using semi-static signaling), and a dynamic or semi-persistent indication (e.g., a DCI message, MAC-CE, or RRC configuration) may be provided to the NCR node 830 to indicate a first configuration, within the first set of configurations, to be used in SBFD time resources, and/or a second configuration, within the second set of configurations, to be used in non-SBFD time resources. For example, as described herein, the configurations to be used in SBFD and/or non-SBFD time resources may include an access link beam used to receive communications from or transmit communications to the UE 820, a backhaul beam used to receive communications from or transmit communications to the network node 810, a power configuration, an amplification configuration, and/or a transmit/receive or forwarding timing alignment configuration, among other examples. Furthermore, in some aspects, a configuration to be used in SBFD and/or non-SBFD time resources may be associated with a single value, a set of values, and/or a range of values for any one or more of the access link beam, the backhaul beam, the power configuration, the amplification configuration, the transmit/receive or forwarding timing alignment configuration, and/or other suitable communication parameters.

Accordingly, as further shown in FIG. 8C, and by reference number 875, the NCR node 830 may forward one or more communications that are received in SBFD time resources using the applicable forwarding configuration, in the forwarding direction that is explicitly or implicitly indicated in the manner described above and/or in accordance with the sub-band filtering capability of the NCR node 830. For example, in some aspects, the NCR node 830 may perform wideband downlink forwarding, wideband uplink forwarding, sub-band downlink forwarding, and/or sub-band uplink forwarding within SBFD time resources based on a dynamic SBFD mode configured or indicated by the network node 810. Additionally, or alternatively, the NCR node 830 may determine the SBFD configuration associated with the SBFD time resources based on an SBFD configuration provided for one or more serving cells or component carriers of the MT component, based on an SBFD configuration provided to the MT component for one or more component carriers that are within the operating bandwidth of the FWD component, and/or based on an index that references a sub-band in a set of uplink and downlink sub-bands that represent the union of all component carriers associated with the MT and FWD components. Additionally, or alternatively, as described herein, the NCR node 830 may use a semi-static configuration associated with the SBFD time resources and/or a dynamic indication of a configuration, within a set of configurations associated with the SBFD time resources, to determine an access beam, a backhaul beam, a power configuration, an amplification configuration, a transmit/receive or forwarding timing alignment configuration, and/or other suitable communication parameters to be used in the one or more SBFD time resources.

As indicated above, FIGS. 8A-8C are provided as examples. Other examples may differ from what is described with regard to FIGS. 8A-8C.

FIG. 9 is a diagram illustrating an example process 900 performed, for example, at a repeater node or an apparatus of a repeater node, in accordance with the present disclosure. Example process 900 is an example where the apparatus or the repeater node (e.g., repeater network node 110d, NCR node 730, NCR node 830, or the like) performs operations associated with SBFD awareness.

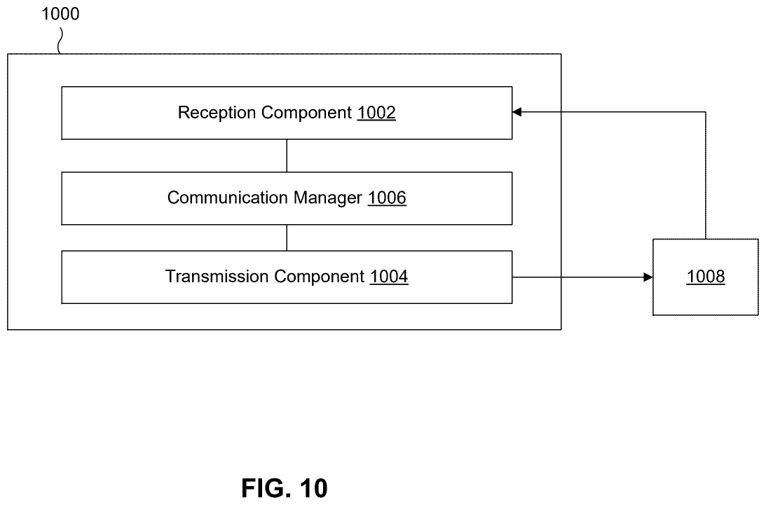

As shown in FIG. 9, in some aspects, process 900 may include receiving, from a network node, SBFD configuration information associated with the network node, wherein the SBFD configuration information indicates one or more SBFD symbols and indicates a forwarding direction for the repeater node in the one or more SBFD symbols (block 910). For example, the repeater node (e.g., using reception component 1002 and/or communication manager 1006, depicted in FIG. 10) may receive, from a network node, SBFD configuration information associated with the network node, wherein the SBFD configuration information indicates one or more SBFD symbols and indicates a forwarding direction for the repeater node in the one or more SBFD symbols, as described above.

As further shown in FIG. 9, in some aspects, process 900 may include forwarding communications that are received in the one or more SBFD symbols in the forwarding direction indicated in the SBFD configuration information (block 920). For example, the repeater node (e.g., using transmission component 1004 and/or communication manager 1006, depicted in FIG. 10) may forward communications that are received in the one or more SBFD symbols in the forwarding direction indicated in the SBFD configuration information, as described above.

Process 900 may include additional aspects, such as any single aspect or any combination of aspects described below and/or in connection with one or more other processes described elsewhere herein.

In a first aspect, the SBFD configuration information indicates one or more time resources associated with the one or more SBFD symbols.

In a second aspect, alone or in combination with the first aspect, the SBFD configuration information indicates one or more uplink sub-bands, one or more downlink sub-bands, and one or more guard bands associated with the one or more SBFD symbols.

In a third aspect, alone or in combination with one or more of the first and second aspects, the forwarding direction is common to all SBFD symbols or separately indicated for different sets of SBFD symbols.

In a fourth aspect, alone or in combination with one or more of the first through third aspects, the forwarding direction is implicitly indicated according to a TDD configuration associated with the one or more SBFD symbols.

In a fifth aspect, alone or in combination with one or more of the first through fourth aspects, the forwarding direction is implicitly indicated according to a TDD configuration associated with one or more non-SBFD symbols that are adjacent to the one or more SBFD symbols.

In a sixth aspect, alone or in combination with one or more of the first through fifth aspects, the forwarding direction is implicitly indicated according to a schedule or one or more operating parameters associated with an MT component of the repeater node during the one or more SBFD symbols.

In a seventh aspect, alone or in combination with one or more of the first through sixth aspects, process 900 includes transmitting, to the network node, information indicating a sub-band filtering capability associated with the repeater node, and the sub-band filtering capability is associated with one or more downlink sub-bands or one or more uplink sub-bands.

In an eighth aspect, alone or in combination with one or more of the first through seventh aspects, the communications are forwarded based at least in part on the communications being received in one or more sub-bands that are not included in the sub-band filtering capability associated with the repeater node.

In a ninth aspect, alone or in combination with one or more of the first through eighth aspects, process 900 includes receiving, in the one or more SBFD symbols, one or more communications in one or more sub-bands that are included in the sub-band filtering capability associated with the repeater node, and filtering, without forwarding, the one or more communications that are received in the one or more sub-bands that are included in the sub-band filtering capability associated with the repeater node.

In a tenth aspect, alone or in combination with one or more of the first through ninth aspects, the SBFD configuration information indicates one or more of a wideband forwarding state or a sub-band forwarding state in one or more of an uplink direction or a downlink direction.

In an eleventh aspect, alone or in combination with one or more of the first through tenth aspects, the SBFD configuration information is indicated for one or more serving cells associated with an MT component of the repeater node.

In a twelfth aspect, alone or in combination with one or more of the first through eleventh aspects, the SBFD configuration information is indicated for one or more component carriers that are non-serving component carriers for an MT component of the repeater node and within an operating bandwidth of an FWD component of the repeater node.

In a thirteenth aspect, alone or in combination with one or more of the first through twelfth aspects, the SBFD configuration information is indicated for multiple uplink sub-bands and multiple downlink sub-bands representing a union of all component carriers associated with an MT component and an FWD component of the repeater node, and the SBFD configuration information includes one or more indexes to identify a subset of the multiple uplink sub-bands and the multiple downlink sub-bands in which the repeater node is to forward the one or more communications received in the one or more SBFD symbols.

In a fourteenth aspect, alone or in combination with one or more of the first through thirteenth aspects, process 900 includes receiving, from the network node, control information that indicates one or more forwarding configurations to be used in the one or more SBFD symbols.

In a fifteenth aspect, alone or in combination with one or more of the first through fourteenth aspects, process 900 includes receiving, from the network node, control information that indicates a first set of forwarding configurations to be used in the one or more SBFD symbols and a second set of forwarding configurations to be used in one or more non-SBFD symbols, and receiving, from the network node, an indication to activate a first forwarding configuration, within the first set of forwarding configurations, to be used in the one or more SBFD symbols and a second forwarding configuration, within the second set of forwarding configurations, to be used in one or more non-SBFD symbols.

In a sixteenth aspect, alone or in combination with one or more of the first through fifteenth aspects, the forwarding direction includes an uplink direction and a downlink direction based at least in part on the repeater node having a bi-directional forwarding capability.

In a seventeenth aspect, alone or in combination with one or more of the first through sixteenth aspects, the SBFD configuration information indicates one or more sub-bands for which the forwarding direction includes an uplink direction and a downlink direction based at least in part on the repeater node having a bi-directional forwarding capability and a sub-band filtering capability.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a repeater node, or a repeater node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 8A-8C. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the network node 110 and/or the UE 120 described in connection with FIG. 2. For example, in some aspects, the apparatus 1000 and/or one or more components shown in FIG. 10 may include one or more components of a network-controlled repeater node, which may include an MT component that includes one or more components of the UE 120 described in connection with FIG. 2 and an FWD component that includes one or more components of the network node 110 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the repeater node described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the repeater node described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a network node, SBFD configuration information associated with the network node, wherein the SBFD configuration information indicates one or more SBFD symbols and indicates a forwarding direction for the repeater node in the one or more SBFD symbols. The transmission component 1004 may forward communications that are received in the one or more SBFD symbols in the forwarding direction indicated in the SBFD configuration information.

The transmission component 1004 may transmit, to the network node, information indicating a sub-band filtering capability associated with the repeater node, wherein the sub-band filtering capability is associated with one or more downlink sub-bands or one or more uplink sub-bands.

The reception component 1002 may receive, in the one or more SBFD symbols, one or more communications in one or more sub-bands that are included in the sub-band filtering capability associated with the repeater node. The communication manager 1006 may filter, without forwarding, the one or more communications that are received in the one or more sub-bands that are included in the sub-band filtering capability associated with the repeater node.

The reception component 1002 may receive, from the network node, control information that indicates one or more forwarding configurations to be used in the one or more SBFD symbols.

The reception component 1002 may receive, from the network node, control information that indicates a first set of forwarding configurations to be used in the one or more SBFD symbols and a second set of forwarding configurations to be used in one or more non-SBFD symbols. The reception component 1002 may receive, from the network node, an indication to activate a first forwarding configuration, within the first set of forwarding configurations, to be used in the one or more SBFD symbols and a second forwarding configuration, within the second set of forwarding configurations, to be used in one or more non-SBFD symbols.

The number and arrangement of components shown in FIG. 10 are provided as an example. In practice, there may be additional components, fewer components, different components, or differently arranged components than those shown in FIG. 10.

Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a repeater node, comprising: receiving, from a network node, SBFD configuration information associated with the network node, wherein the SBFD configuration information indicates one or more SBFD symbols and indicates a forwarding direction for the repeater node in the one or more SBFD symbols; and forwarding communications that are received in the one or more SBFD symbols in the forwarding direction indicated in the SBFD configuration information.

Aspect 2: The method of Aspect 1, wherein the SBFD configuration information indicates one or more time resources associated with the one or more SBFD symbols.

Aspect 3: The method of Aspect 2, wherein the SBFD configuration information indicates one or more uplink sub-bands, one or more downlink sub-bands, and one or more guard bands associated with the one or more SBFD symbols.

Aspect 4: The method of any of Aspects 1-3, wherein the forwarding direction is common to all SBFD symbols or separately indicated for different sets of SBFD symbols.

Aspect 5: The method of any of Aspects 1-4, wherein the forwarding direction is implicitly indicated according to a TDD configuration associated with the one or more SBFD symbols.

Aspect 6: The method of any of Aspects 1-5, wherein the forwarding direction is implicitly indicated according to a TDD configuration associated with one or more non-SBFD symbols that are adjacent to the one or more SBFD symbols.

Aspect 7: The method of any of Aspects 1-6, wherein the forwarding direction is implicitly indicated according to a schedule or one or more operating parameters associated with an MT component of the repeater node during the one or more SBFD symbols.

Aspect 8: The method of any of Aspects 1-7, further comprising: transmitting, to the network node, information indicating a sub-band filtering capability associated with the repeater node, wherein the sub-band filtering capability is associated with one or more downlink sub-bands or one or more uplink sub-bands.

Aspect 9: The method of Aspect 8, wherein the communications are forwarded based at least in part on the communications being received in one or more sub-bands that are not included in the sub-band filtering capability associated with the repeater node.

Aspect 10: The method of Aspect 8, further comprising: receiving, in the one or more SBFD symbols, one or more communications in one or more sub-bands that are included in the sub-band filtering capability associated with the repeater node; and filtering, without forwarding, the one or more communications that are received in the one or more sub-bands that are included in the sub-band filtering capability associated with the repeater node.

Aspect 11: The method of any of Aspects 1-10, wherein the SBFD configuration information indicates one or more of a wideband forwarding state or a sub-band forwarding state in one or more of an uplink direction or a downlink direction.

Aspect 12: The method of any of Aspects 1-11, wherein the SBFD configuration information is indicated for one or more serving cells associated with an MT component of the repeater node.

Aspect 13: The method of any of Aspects 1-12, wherein the SBFD configuration information is indicated for one or more component carriers that are non-serving component carriers for an MT component of the repeater node and within an operating bandwidth of an FWD component of the repeater node.

Aspect 14: The method of any of Aspects 1-13, wherein the SBFD configuration information is indicated for multiple uplink sub-bands and multiple downlink sub-bands representing a union of all component carriers associated with an MT component and an FWD component of the repeater node, and wherein the SBFD configuration information includes one or more indexes to identify a subset of the multiple uplink sub-bands and the multiple downlink sub-bands in which the repeater node is to forward the one or more communications received in the one or more SBFD symbols.

Aspect 15: The method of any of Aspects 1-14, further comprising: receiving, from the network node, control information that indicates one or more forwarding configurations to be used in the one or more SBFD symbols.

Aspect 16: The method of any of Aspects 1-15, further comprising: receiving, from the network node, control information that indicates a first set of forwarding configurations to be used in the one or more SBFD symbols and a second set of forwarding configurations to be used in one or more non-SBFD symbols; and receiving, from the network node, an indication to activate a first forwarding configuration, within the first set of forwarding configurations, to be used in the one or more SBFD symbols and a second forwarding configuration, within the second set of forwarding configurations, to be used in one or more non-SBFD symbols.

Aspect 17: The method of any of Aspects 1-16, wherein the forwarding direction includes an uplink direction and a downlink direction based at least in part on the repeater node having a bi-directional forwarding capability.

Aspect 18: The method of any of Aspects 1-17, wherein the SBFD configuration information indicates one or more sub-bands for which the forwarding direction includes an uplink direction and a downlink direction based at least in part on the repeater node having a bi-directional forwarding capability and a sub-band filtering capability.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A repeater node for wireless communication, comprising:
one or more memories; and
one or more processors, coupled to the one or more memories, configured to cause the repeater node to:
receive, from a network node, sub-band full-duplex (SBFD) configuration information associated with the network node, wherein the SBFD configuration information indicates one or more SBFD symbols and indicates a forwarding direction for the repeater node in the one or more SBFD symbols; and
forward communications that are received in the one or more SBFD symbols in the forwarding direction indicated in the SBFD configuration information.

2. The repeater node of claim 1, wherein the SBFD configuration information indicates one or more time resources associated with the one or more SBFD symbols.

3. The repeater node of claim 2, wherein the SBFD configuration information indicates one or more uplink sub-bands, one or more downlink sub-bands, and one or more guard bands associated with the one or more SBFD symbols.

4. The repeater node of claim 1, wherein the forwarding direction is common to all SBFD symbols or separately indicated for different sets of SBFD symbols.

5. The repeater node of claim 1, wherein the forwarding direction is implicitly indicated according to a time division duplexing configuration associated with the one or more SBFD symbols.

6. The repeater node of claim 1, wherein the forwarding direction is implicitly indicated according to a time division duplexing configuration associated with one or more non-SBFD symbols that are adjacent to the one or more SBFD symbols.

7. The repeater node of claim 1, wherein the forwarding direction is implicitly indicated according to a schedule or one or more operating parameters associated with a mobile termination component of the repeater node during the one or more SBFD symbols.

8. The repeater node of claim 1, wherein the one or more processors are further configured to cause the repeater node to:
transmit, to the network node, information indicating a sub-band filtering capability associated with the repeater node, wherein the sub-band filtering capability is associated with one or more downlink sub-bands or one or more uplink sub-bands.

9. The repeater node of claim 8, wherein the communications are forwarded based at least in part on the communications being received in one or more sub-bands that are not included in the sub-band filtering capability associated with the repeater node.

10. The repeater node of claim 8, wherein the one or more processors are further configured to cause the repeater node to:
receive, in the one or more SBFD symbols, one or more communications in one or more sub-bands that are included in the sub-band filtering capability associated with the repeater node; and
filter, without forwarding, the one or more communications that are received in the one or more sub-bands that are included in the sub-band filtering capability associated with the repeater node.

11. The repeater node of claim 1, wherein the SBFD configuration information indicates one or more of a wideband forwarding state or a sub-band forwarding state in one or more of an uplink direction or a downlink direction.

12. The repeater node of claim 1, wherein the SBFD configuration information is indicated for one or more serving cells associated with a mobile termination component of the repeater node.

13. The repeater node of claim 1, wherein the SBFD configuration information is indicated for one or more component carriers that are non-serving component carriers for a mobile termination component of the repeater node and within an operating bandwidth of a forwarding component of the repeater node.

14. The repeater node of claim 1, wherein the SBFD configuration information is indicated for multiple uplink sub-bands and multiple downlink sub-bands representing a union of all component carriers associated with a mobile termination component and a forwarding component of the repeater node, and wherein the SBFD configuration information includes one or more indexes to identify a subset of the multiple uplink sub-bands and the multiple downlink sub-bands in which the repeater node is to forward the one or more communications received in the one or more SBFD symbols.

15. The repeater node of claim 1, wherein the one or more processors are further configured to cause the repeater node to:
receive, from the network node, control information that indicates one or more forwarding configurations to be used in the one or more SBFD symbols.

16. The repeater node of claim 1, wherein the one or more processors are further configured to cause the repeater node to:
receive, from the network node, control information that indicates a first set of forwarding configurations to be used in the one or more SBFD symbols and a second set of forwarding configurations to be used in one or more non-SBFD symbols; and
receive, from the network node, an indication to activate a first forwarding configuration, within the first set of forwarding configurations, to be used in the one or more SBFD symbols and a second forwarding configuration, within the second set of forwarding configurations, to be used in one or more non-SBFD symbols.

17. The repeater node of claim 1, wherein the forwarding direction includes an uplink direction and a downlink direction based at least in part on the repeater node having a bi-directional forwarding capability.

18. The repeater node of claim 1, wherein the SBFD configuration information indicates one or more sub-bands for which the forwarding direction includes an uplink direction and a downlink direction based at least in part on the repeater node having a bi-directional forwarding capability and a sub-band filtering capability.

19. A method of wireless communication performed by a repeater node, comprising:
receiving, from a network node, sub-band full-duplex (SBFD) configuration information associated with the network node, wherein the SBFD configuration information indicates one or more SBFD symbols and indicates a forwarding direction for the repeater node in the one or more SBFD symbols; and
forwarding communications that are received in the one or more SBFD symbols in the forwarding direction indicated in the SBFD configuration information.

20. An apparatus for wireless communication, comprising:
means for receiving, from a network node, sub-band full-duplex (SBFD) configuration information associated with the network node, wherein the SBFD configuration information indicates one or more SBFD symbols and indicates a forwarding direction for the apparatus in the one or more SBFD symbols; and
means for forwarding communications that are received in the one or more SBFD symbols in the forwarding direction indicated in the SBFD configuration information.
